(19) United States
(12) Patent Application Publication
(10) Pub. No.: US 2002/0065911 A1
(43) Pub. Date: May 30, 2002

(54) HTTP transaction monitor with edit and replay capacity

(76) Inventors: Ana H. von Klopp, San Francisco, CA (US); George C. Finklang, San Francisco, CA (US); Thomas D. Gleason, La Honda, CA (US)

Correspondence Address: ROSENTHAL & OSHA L.L.P., 1221 MCKINNEY AVENUE, SUITE 2800, HOUSTON, TX, 77010, US

(21) Appl. No.: 09/874,888

(22) Filed: Jun. 5, 2001

Related U.S. Application Data
(60) Provisional application No. 60/237,823, filed on Oct. 3, 2000.

(51) Int. Cl. G06F 15/173

(52) U.S. Cl. 709/224; 714/46

(57) ABSTRACT

A mechanism for monitoring data flow in a web application hosted on a server includes a directory in which HTTP transactions processed on the server are stored, a display through which a request associated with a selected HTTP transaction in the directory can be re-executed in order to recreate the selected HTTP transaction, and an editor through which request data associated with the request can be modified prior to re-executing the request.

### CROSS-REFERENCE TO RELATED APPLICATIONS

This application claims priority from U.S. Provisional Application Ser. No. 60/237,823, filed Oct. 3, 2000. This application is related to original U.S. patent application Ser. No. 09/730,686, entitled “HTTP Transaction Monitor,” filed Dec. 6, 2000, and original U.S. patent application Ser. No. 09/789,238, entitled “HTTP Transaction Monitor with Replay Capacity,” filed Feb. 20,2001.

### COPYRIGHT STATEMENT

A portion of the disclosure of this patent document contains material which is subject to copyright protection. The copyright owner has no objection to the facsimile reproduction by anyone of the patent document or the patent disclosure, as it appears in the Patent and Trademark Office file or records, but otherwise reserves all copyright rights whatsoever.

### TERMINOLOGY

The following glossary of some terms are helpful in understanding the background discussion and the detailed description of the invention.

API (Application Programming Interface)—An interface for application programs and utilities to access the internal services provided by the software that comprises the API.

Applet—A Java™ program embedded in a HTML document and executed in a Java™-enabled browser.

ASP™ (Active Server Pages™)—A scripting environment developed by Microsoft Corporation. ASP™ allows HTML, scripts, and ActiveX components to be combined to create dynamic web pages.

Bean—A JavaBeans™ component.

CGI (Common Gateway Interface)—A standard for running external programs from a HTTP server.

CGI Script—A small program written in a script language such as Perl that can be invoked through a request to the web server.

Class—A user-defined data type that defines a collection of objects that share the same characteristics. An object is one instance of the class.

Client—A program, often including a user interface, which initiates contact with another program (a server) for the purposes of exchanging data. The server runs in a different process and/or on a different host from the client.

Cookie—A packet of information sent by an HTTP server to a web browser and then sent back by the browser each time the browser accesses the same resource on the server or any other set of resources that is declared by the cookie. Cookies are used to maintain state between HTTP transactions. Cookies are not visible to the browser user.

DHTML (Dynamic HTML)—An extension of HTML. DHTML gives greater control over the layout of page elements and the ability to have web pages which change and interact with the user without having to communicate with the server.

Directory—A simulated file folder on disk.

E-commerce (Electronic commerce)—Typically implies purchasing products via the Web. It also covers electronic data interchange, in which one company's computer queries and transmits purchase orders to another company's computer.

Execution Server—An HTTP server that is used by an IDE for the purposes of assisting with the processes of developing dynamic web components. The IDE uses the execution server to run JSPs and servlets, or dynamic page generation components in general.

GUI (Graphical User Interface)—A graphics-based interface that incorporates, for example, icons, menus, and text entry areas and allows for non-linear user interaction (as opposed to character-based interfaces where the user enters data by answering questions in a set order).

Hook—Programming instructions that provide breakpoints for future expansion. Hooks can be used to call some outside routine or function or may be places where additional processing is added.

HTML (HyperText Markup Language)—A hypertext document format used on the World Wide Web.

HTTP (Hypertext Transfer Protocol)—An application-level protocol for distributed, collaborative, hypermedia information systems.

HTTP Request—A message sent by a client to a server using HTTP. The first line of the request contains the method to be applied to the resource requested, the identifier of the resource, and the protocol version in use. The first line is followed by HTTP headers, lines which provide information about the client, which are optionally followed by a data stream.

HTTP Response—A message sent to a client after the HTTP server receives and interprets a request message from the client. The first line of the response includes the protocol version used by the server and a success or error code. The first line is followed by HTTP headers with information about the server and about the (optional) body content that follows the headers as a data stream.

HTTP Server—A server process which processes HTTP requests.

HTTP Session—Part of the Java Servlet™ API. Allows the HTTP server to maintain state between different HTTP requests. The HTTP server knows which session to associate with the request because the browser sends the session ID as part of the request. This can either be done with a cookie or by adding a parameter to the request URL.

IDE (Integrated Development Environment)—An application that facilitates the process of writing software. An IDE typically includes a syntax-based editor, graphical tools for program entry, and integrated support for compiling, executing, and debugging the program.

IDE Session—The instance of an IDE (and all its internal states) that is created when the user starts up and uses the IDE. The session ends when the user exits the IDE instance.

Internal HTTP Server—Sometimes referred to as internal server. An HTTP server that runs in the same process of an application for the purposes of providing services to it.

J2EE—Java™ 2 Platform, Enterprise Edition.

JavaBeans™—A component software architecture that runs in the Java™ environment, initially developed by Sun Microsystems, Inc. JavaBeans™ allows developers to create reusable components that can be assembled together using a visual application builder tool.

JSP™ (JavaServer Pages™)—A specification to extend the JavaServlet™ API to generate dynamic web pages on a web server. It includes a set of tags in XML format for creating dynamic content in web pages. In order to use JSP™ on a web server, the web server needs a JSP™ engine and a servlet engine. The JSP™ engine is responsible for generating a servlet from the JSP™ page and maintaining a name convention such that the servlet is invoked when the JSP™ page is processed. JSP™ was developed by Sun Microsystems, Inc.

JSP™ Page—A text-based document that uses fixed template data and JSP™ elements and describes how to process a request to create a response. The template data consists of JSP™ tags embedded in static content which is typically HTML.

LRI (Local Resource Identifier)—The location of a resource relative to the hierarchical structure of the server, e.g., a path relative to the server's document root if the resource is a file.

Plug-in—An auxiliary program that works with a major software package to enhance its capability.

Process—An executing program with its own internal data states that are not accessible to other processes.

Web Resource—A network data object or service that can be identified by a URI.

Server—An application program that accepts connections in order to service requests by sending back responses.

Servlet—A Java™ program that runs exclusively in a servlet engine which is an extension to a web server.

URL (Uniform Resource Locator)—A compact string representative of resources available via the network. A URL has the form <protocol>://<server name><LRI><?optional parameters>.

Virtual Machine—A self-contained operating environment that behaves as if it is a separate computer. A Java™ virtual machine is a Java™ interpreter that converts Java byte code into machine language one at a time and then executes it.

Web Browser—A client application that requests resources from a web server, usually for the purpose of displaying them. Examples of browsers are Microsoft® Internet Explorer and Netscape Navigator.

XML (eXtensible Markup Language)—A mark-up language that provides a format for describing structured data.

### BACKGROUND OF INVENTION

1. Field of the Invention

The invention relates generally to web application development systems. More specifically, the invention relates to a mechanism for monitoring data flow in a web application, particularly during testing and debugging of the web application.

2. Background Art

A web application is a web site where users can access the information they need and change the state of application logic on a server through a set of web pages. Development of web applications is usually centered around tools and technologies. A web application centered around the Java™ technology may include the following: JSP™ pages and Java™ servlets that handle HTTP requests and generate dynamic content, server-side beans that encapsulate application behavior and state, static HTML files, DHTML files, image files, sound files, and libraries with additional Java™ components, such as client-side Java™ applets and any Java™ class files used by the other Java™ components. The J2EE™ specification describes a standard for how to organize such files into web modules, including describing how they are accessed. The web modules could be developed in an IDE, such as sold under the trade name Forte™ for Java™ by Sun Microsystems, Inc.

The process of test-running and debugging web applications that provide dynamic responses to different user inputs involves testing each component that generates pages with every possible type of user input. This includes user input that is technically incorrect (e.g., entering “&&ˆ ˆ %” into a field where the expected input is a U.S. zip code). To understand how the test-running and debugging process works, it is useful to consider a specific example. Consider a portion of a web application that deals with entering billing and shipping addresses for the purpose of allowing the user to purchase goods or services. Assume that the web application includes page-generation components JSP_A and JSP_B, respectively. Components JSP_A and JSP_B could be JSP™ pages, for example. JSP_A generates a page A that displays an HTML form in a browser where the user can enter billing and shipping addresses and press a “Continue” button to submit the information. Pressing the “Continue” button causes the browser to make a HTTP request to JSP_B with the data from the form fields as request parameters. If the address information is valid, JSP_B generates a page B which displays the addresses as text and asks the user to confirm that the addresses are correct. If the address information is invalid (e.g., because of a missing phone number or a zip code which contains characters other than digits), JSP_B forwards the request back to JSP_A, which regenerates page A with some extra messages that point to invalid entries.

Now, suppose that the user has identified a problem with how the input from one of the form fields in page A is processed by JSP_B. The user will attempt to fix the bug and then re-execute JSP_B with the same input from page A. In this situation, it is clearly desirable for the user to be able to resubmit the request from page A without having to reenter the same data into the page's input fields. However, this may not be possible for several reasons. First, it is common for dynamically generated pages to include a HTTP directive which specifies that the page should not be cached (by the browser or by a proxy server). This means that the browser's “Back” or “Reload” button would not populate the page's input fields with the previously entered data. Using the “Back” button would cause the form from which the HTTP request was created to be regenerated, losing any data that was previously entered. With reference to the example above, this means that if the user used the “Back” button to display page A, all the data the user previously entered on page A would be lost, so the user cannot just select the “Continue” button to resubmit the same request. The user can work around this by disabling the directive, but that involves extra work and remembering to enable it again later.

Similarly, using the “Reload” button to regenerate page B with the same input data might fail, though this depends on the implementation of the browser. Some browsers, e.g., Netscape Navigator, cache HTTP requests as well as HTTP responses, enabling the user to use the “Reload” button to resubmit the same request even if the resulting page has a directive that prevents it from being cached. However, there are situations where this might not work either, such as when the problematic input from page A causes page B to redirect or forward the request to page A. Of course, caching HTTP requests also only works until the request is dropped from the browser's cache. This will typically happen if the browser window is used to display some other pages, or if the browser process is terminated.

The only way that the user can ensure that the request can be resubmitted is by creating a bookmark for it. However, browsers typically do not make it possible to specify that the URL should be sent as a POST request, which is how data from a form is usually sent. This leaves the user with the possibility of hard-coding the data values for a particular POST request on a specific web page that is used for testing purposes only. This again is not a very attractive option. In short, there is no easy way for users to debug HTTP requests that result from HTML forms, especially if the work stretches over time. Sooner or later the user will have to fill in the same data again, which is time consuming and does not contribute directly to solving the problem.

The invention described in U.S. patent application Ser. No. 09/789,238, supra, discloses a mechanism for collecting data about the HTTP transactions that result from HTTP requests processed by the server and replaying the HTTP transactions for which data has been collected. Using this mechanism, the developer can save the HTTP request sent to JSP_B and then replay the HTTP request during the process of debugging JSP_B, eliminating the need to repeatedly fill the form. However, suppose that during the process of debugging JSP_B, the developer realizes that it is likely that another form field in page A could cause a similar problem. In order to test if the form field could cause a similar problem, the developer would have to bring up page A in the browser and fill the form again, even though only the data in the form field to be tested needs modification Similarly, the developer would have to fill the form again whenever there is a desire to change another parameter, e.g., the locale setting of the browser or other browser information.

### SUMMARY OF INVENTION

In one aspect, the invention relates to a mechanism for monitoring data flow in a web application hosted on a server which comprises a directory in which HTTP transactions processed on the server are stored, a display through which a request associated with a selected HTTP transaction in the directory can be re-executed in order to recreate the selected HTTP transaction, and an editor through which request data associated with the request can be modified prior to re-executing the request.

In another aspect, the invention relates to a mechanism for monitoring data flow in a web application hosted on a server which comprises a data collector that selectively intercepts HTTP transactions processed on the server in order to collect data passed between components of the web application, a display through which a request associated with a selected HTTP transaction for which data has been collected can be sent to the server, and an editor through which request data associated with the request can be modified prior to re-executing the request.

In another aspect, the invention relates to a method for monitoring data flow in a web application hosted on a server which comprises obtaining an HTTP transaction processed on the server while interacting with the web application, the HTTP transaction having an associated request. The method further includes editing request data associated with the request, reconstructing the request using the edited request data, and re-executing the request in order to recreate the HTTP transaction.

In another aspect, the invention relates to a system for testing and debugging a web application which comprises a server hosting the web application, a directory in which HTTP transactions processed on the server are stored, a client through which a request associated with a selected HTTP transaction in the directory can be re-executed in order to recreate the selected HTTP transaction, and an editor through which request data associated with the request can be modified prior to re-executing the request.

In another aspect, the invention relates to a mechanism for monitoring data flow in a web application hosted on a server which includes means for storing HTTP transactions processed on the server, means for re-executing a request associated with a selected HTTP transaction in the directory in order to recreate the selected HTTP transaction, and means for modifying request data associated with the request prior to re-executing the request.

Other aspects and advantages of the invention will be apparent from the following description and the appended claims.

### BRIEF DESCRIPTION OF DRAWINGS

FIG. 1 shows a block diagram of a testing/debugging system incorporating a HTTP transaction monitor according to one embodiment of the invention.

FIGS. 2A and 2B show a representation of a display for the HTTP transaction monitor.

FIGS. 3A-3D show different views of an HTTP request editor.

FIG. 4 shows the display for the HTTP transaction monitor invoked from an IDE.

FIG. 5 illustrates how the HTTP transaction monitor interacts with a server.

### DETAILED DESCRIPTION

Embodiments of the invention provide a tool for editing and replaying HTTP requests during testing and debugging of a web application. The tool allows transactions resulting from HTTP requests processed on a server to be re-executed at a later time. Before re-executing a transaction, the tool allows the user to modify the HTTP request. For example, the user can create a query string if the original request did not include one, or the user can modify an existing query string by adding new parameter/value pairs or by modifying or deleting existing ones. Similarly, the user can change data that was passed in through a POST or PUT request. The user can also change the hostname and port of the server instance associated with the request, change the URI and HTTP method of the request, and so forth. Using the tool of the present invention, the user can replay a transaction that requires parameters that are set by entering input on a HTML form without having to fill out the form again. One of the advantages of the present invention is that the need to fill an entire form for the purpose of modifying the data in one or two of the form fields is eliminated. This allows the user to quickly verify if a problem expected to be encountered during processing of the form data really occurs. The result is a reduction in testing and debugging time.

Another advantage of the tool of the present invention is that the user can change client information prior to re-executing the transaction. For example, suppose that the user is debugging a web application that is sensitive to the locale setting of the client making the HTTP request, where locale setting indicates what language the user wants to use and certain formatting preferences. Assume that the HTML pages generated by the web application should display text in the language preferred by the user, or in English if the language is unsupported. With the present invention, the user can make a request for a resource using any or no locale setting. The tool will save this request. The user can then replay this request with a different locale setting by modifying the HTTP headers of the request. Without the present invention, the user would have to generate a HTTP request for each locale setting desired to be tested, which requires reconfiguring the web browser.

In the description of the invention which follows, a web application containing JSPs™ and servlets is used to illustrate the principles of the invention. However, it would be understood by one of ordinary skill in the art that the principles of the invention are applicable to web applications containing other types of dynamic page generation components such as ASPs™ and CGI scripts. Also, for convenience, the following description is outlined into five principal sections, including Architecture Overview, Storing and Managing HTTP Transaction Data, HTTP Transaction Monitor GUI, HTTP Transaction Monitor Server-Side Functionality, and Operation.

### Architecture Overview

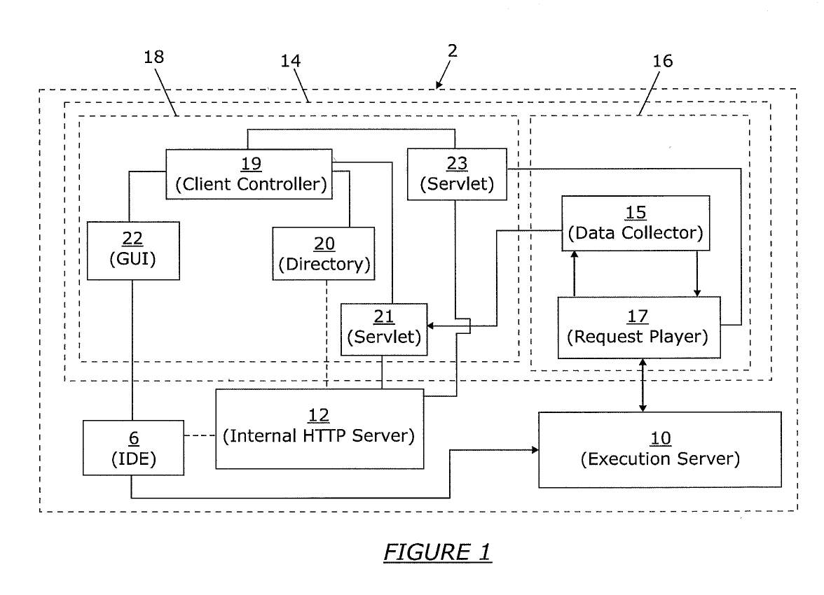

FIG. 1 shows a block diagram of a testing/debugging system 2 which includes an embodiment of the invention. The testing/debugging system 2 includes an IDE 6 which can be used to design, compile, execute, test, and debug components of a web application. In one embodiment, the IDE 6 is a Java™ application which consists of byte codes that are interpreted by a Java™ Virtual Machine (not shown). However, the IDE 6 may be written in another programming language, e.g., C++. When the IDE 6 is started, a GUI (not shown) is displayed through which a developer can develop and/or view the components of the web application. Further, the IDE 6 can execute the web application components in a HTTP server that is running in a separate process. This HTTP server will be referred to as the execution server 10. The execution server 10 may be started, for example, when a user selects a file representation of a JSP™ page (not shown) from the IDE 6. The execution server 10 may be on the same host machine as the IDE 6 or may be on a different host machine.

In accordance with one embodiment of the invention, a HTTP transaction monitor 14 includes a server-side component 16 and a client-side component 18. The server-side component 16 collects data about transactions resulting from HTTP requests processed on the execution server 10. The transactions can either be initiated by the IDE 6 or through an external HTTP client, e.g., a browser, pointed to the host and port of the execution server 10. The server-side component 16 includes a data collector 15 that is responsible for collecting data before and after the execution server 10 processes the HTTP requests. In one implementation, the data collector 15 runs on the execution server 10 and relies on hooks in the execution server 10 to intercept HTTP requests in order to collect data about them. In an alternate embodiment, the data collector 15 uses hooks in a server plug-in (e.g., a servlet engine) that handles the dynamic components of the web application to intercept HTTP requests in order to collect data about them.

The server-side component 16 also includes a request player 17 running on the execution server 10. The request player 17 detects a special type of HTTP request, called a “replay request”. The replay request indicates that a prior HTTP transaction should be re-executed. In one embodiment, the replay request includes data that allows the request player to retrieve the corresponding transaction record from the client-side component 18. The transaction record contains the request data, i.e., the IP address of the client from which the HTTP request originated, the HTTP method, the request URI, the protocol version, any query string and parameters, and all the HTTP headers, needed to recreate the prior HTTP request. After the request player 17 modifies the replay request, the modified replay request is transferred to the data collector 15 for data collection and then processed by the execution server 10. In one implementation, the request player 17 relies on hooks in the execution server 10 or hooks in a server plug-in (e.g., a servlet engine) to intercept requests coming into the execution server 10 in order to determine whether the requests are replay requests.

The client-side component 18 includes a GUI 22 for displaying data about the HTTP requests for which the server-side component 16 has collected data. The GUI 22 also allows the user to send a replay request to the execution server 10. Replay requests may also be sent programmatically to the execution server 10. The request data associated with the replay request may correspond exactly to the original request data associated with the prior HTTP transaction to be re-executed or may be a modification of the original request data. In one implementation, the GUI 22 is accessible from the IDE 6, and the IDE 6 includes a mechanism through which the data collector 15 can notify the client-side component 18 of HTTP requests processed by the execution server 10. This mechanism can be a HTTP server 12 which is built into the IDE 6 and configurable from the IDE 6. If the HTTP transaction monitor 14 is run as a standalone application, then the client-side component 18 would be responsible for maintaining the mechanism through which it is notified when the execution server 10 processes a new HTTP request.

For each HTTP transaction that the execution server 10 processes, the data collector 15 collects the five categories of data shown in Table 1. In addition to the categories of data shown in Table 1, the data collector 15 generates the information required to list the transaction in the GUI 22. In one embodiment, this information includes the ID of the transaction, the HTTP method, the LRI of the request, and timestamp of the transaction. Additional data may be included to generate more detailed list entries.

TABLE 1
Categories of Data Collected by Server-Side Component

| Category | List of Data Collected |
|---|---|
| Request | The IP address of the host from which the request was sent, |
| | the HTTP method, the LRI, path information (if appropriate), |
| | the query string, the protocol version, the referrer (if |
| | appropriate), the value of any incoming parameters, and the |
| | exit status of the HTTP response. All HTTP headers |
| | associated with request. |
| Cookies | List of incoming and outgoing cookies. For incoming cookies, |
| | the name and value is provided. For outgoing cookies, the |
| | name, value, domain, time to live, path and whether the |
| | cookie requires secure protocol. |
| Session | Whether the session exists before and after the transaction. |
| | Which attributes were set and what their values are before and |
| | after the transaction. The session s properties: its ID, when it |
| | was created, its maximum inactive interval, and when it was |
| | last accessed. |
| Servlet/ | Name of the servlet as configured, its class name, its package |
| Server | name, the description given by the developer, and the relative |
| Properties | path to the servlet. The servlet’s initialization parameters, if |
| | there are any. The absolute path to the J2EE ™ context. The |
| | servlet engine’s properties (Java ™ Development Kit and |
| | platform). |
| Client | The version of the HTTP protocol, the client’s IP address, any |
| | other information provided through the HTTP headers such as |
| | the nature of the client, e.g., the type and version of the |
| | browser, the user’s language preference, and what formats and |
| | character sets the browser can deal with. |

### Storing and Managing HTTP Transaction Data

The client-side component 18 includes a mechanism for receiving notification of new HTTP transactions, which are subsequently listed on the GUI 22. In one embodiment, this functionality is handled by a servlet 21 that runs on the internal HTTP server 12 and is called whenever the server-side component 16 records a new transaction. In one implementation, notification of a newly recorded transaction is sent to the servlet 21 in the form of a HTTP POST request with a query string appended to the URL and the transaction data (in a structured format such as XML) as the posted data. The POST request identifies the name of the host on which the IDE 6 is running and the port number of the internal HTTP server 12. The query string has the general format: ID|METHOD|RESOURCE, where <ID> is a string that uniquely identifies the transaction, <METHOD> is the HTTP method of the original request, and <RESOURCE> is the path relative to the server root to the resource that was accessed by the original request. The data from the query string is also part of the XML representation. The query string is simply used to add a new transaction to the list in GUI 22 without requiring the entire transaction record to be processed at notification time. Notification of newly recorded transactions may also be sent programmatically to the servlet 21. To do this, a POST request is issued to the servlet 21 with a query string such as described above appended to the URL. Then, a file (typically in a structured format such as XML) containing the transaction data is sent to the servlet 21.

In one embodiment the client-side component 18 uses a directory 20 to store transaction files. The client-side component 18 uses normal file operations to access and manipulate the data. In one implementation, the directory 20 has three subdirectories: “current,” “save,” and “replay.” When the client-side component 18 is notified that the execution server 10 has processed a new request, the corresponding transaction is stored in a new file called <id>.xml under the directory “current,” where <ID> is the unique identifier described above, and xml is the extension required for xml files. The GUI 22 interacts with the directory 20 through a client controller 19. When the user elects to save a transaction through the GUI 22, the user marks the transaction as saved through the GUI 22. This causes the corresponding files to be moved from the “current” directory to the “save” directory. It should be noted that there may be other ways of keeping track of whether the transactions are current or saved. When the user elects to edit and replay a transaction through the GUI 22, a dialog is displayed which allows the user to edit the transaction. The changes are saved in a temporary file (also called <id>.xml) in the “replay” directory. Upon exiting the IDE 6, the files in the “current” and “replay” directories may be deleted to conserve disk space. Files in the “saved” directory remain until they are explicitly deleted by the user.

### HTTP Transaction Monitor GUI

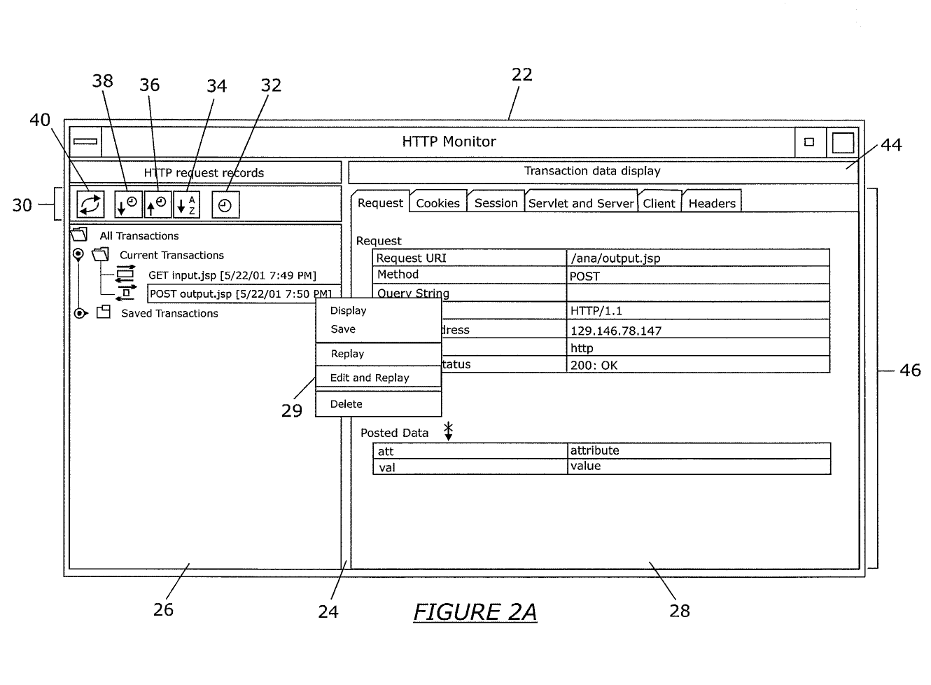

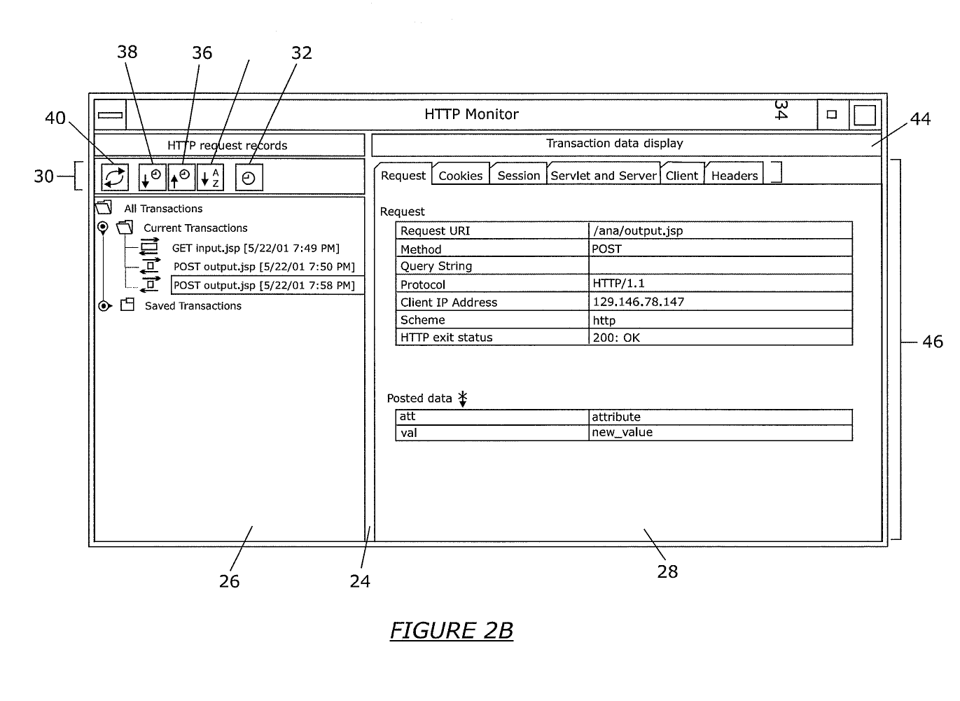

In one implementation, the GUI 22 is a software component or application that can be called from within the IDE (6 in FIG. 1). FIG. 2A shows a representation of the GUI 22. In the figure, the GUI 22 includes a single frame 24 having a left pane 26 and a right pane 28. The GUI 22 displays a list of transactions on the left pane 26 and data for an individual transaction on the right pane 28.

The left pane 26 displays one supercategory node “All Transactions.” Under the supercategory node “All Transactions” are subcategory nodes “Current Transactions” and “Saved Transactions.” Individual transactions are leaf nodes and reside in either the “Current Transactions” subcategory or the “Saved Transactions” subcategory. Entries in the “Current Transactions” subcategory are available during the current IDE session, while entries in the “Saved Transactions” subcategory persist until they are deleted by the user. The entries in the “Current Transactions” and “Saved Transactions” are obtained from the directory (20 in FIG. 1). A row of buttons 30 above the transaction list allows the user to reload all transactions and to modify display parameters. The button 32 reloads all the transactions. The button 34 displays transactions in alphabetical order, by LRI. The button 36 displays the transactions in temporal order, last transaction last. The button 38 displays the transactions in reverse temporal order, last transaction first. The button 40 toggles whether the time stamp of the transaction is shown or not.

The right pane includes a display component 44 having six tabs, collectively indicated at 46. For a transaction selected on the left pane 26, the six tabs 46 display the data collected by the server component (16 in FIG. 1) according to the categories shown in Table 1 above. The six tabs 46 have the labels “Request,” “Cookies,” “Session,” “Servlet and Server,” “Client,” and “Headers,” respectively. The “Request” tab displays the request and response parameters for a selected transaction. The HTTP headers associated with the request are displayed separately in the “Headers” tab. The “Cookies” tab displays attributes of incoming and outgoing cookies for a selected transaction. The “Session” tab displays the session status before and after executing the selected transaction. The “Servlet and Server” tab displays the servlet and server properties when the selected transaction was executed. The “Client” tab displays properties of the client making the request for the selected transaction.

Individual transaction nodes in the “Current Transactions” subcategory have five actions: “Display,” “Save,” “Replay,” “Edit and Replay,” and “Delete.” In the “Saved Transactions” subcategory, the individual transaction nodes have four actions: “Display,” “Replay,” “Edit and Replay,” and “Delete.” In one implementation, the list of actions available under each transaction category is displayed in a pop-up menu 29 when the user right-clicks on a transaction. The “Display” action causes data about the corresponding transaction to be shown in the right pane 28. The data can also be displayed simply by selecting the node. The “Save” action causes the client-side component (18 in FIG. 1) itself to mark the corresponding transaction records as saved and moves the node from the “Current Transactions” folder to the “Saved Transactions” folder. Similarly, the “Delete” action causes the records for the corresponding transactions to be deleted and the deleted transaction's node removed from the GUI 22.

The “Replay” action causes a selected HTTP transaction to be re-executed by the execution server (10 in FIG. 1). In one embodiment, the “Replay” action sends a replay request to the execution server (10 in FIG. 1) which includes a pointer to the request data for the selected HTTP transaction. The replay request includes a special query string that indicates that it is a replay request. The request player (17 in FIG. 1) detects the replay request and instructs the client controller (19 in FIG. 1) to retrieve request data from the directory 20 using the pointer in the replay request. The request player (17 in FIG. 1) then reconstructs the replay request using the request data. In another embodiment, the “Replay” action sends a request to the execution server (10 in FIG. 1) with the request data for the selected HTTP transaction. In one implementation, the HTTP response from the execution server (10 in FIG. 1) is displayed in the same browser that the IDE (6 in FIG. 1) uses to display HTTP responses from JSPs™ that are executed through the IDE (6 in FIG. 1). In an alternate embodiment, if the HTTP transaction monitor (14 in FIG. 1) is used as a standalone tool, the HTTP response may be displayed in an external browser. The user can configure the HTTP transaction monitor (14 in FIG. 1) to use a browser of choice.

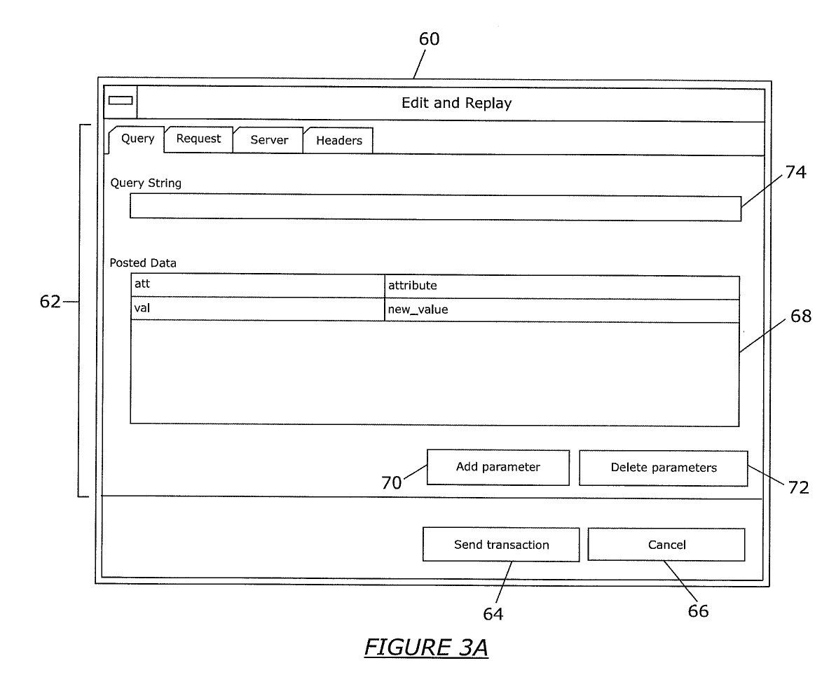

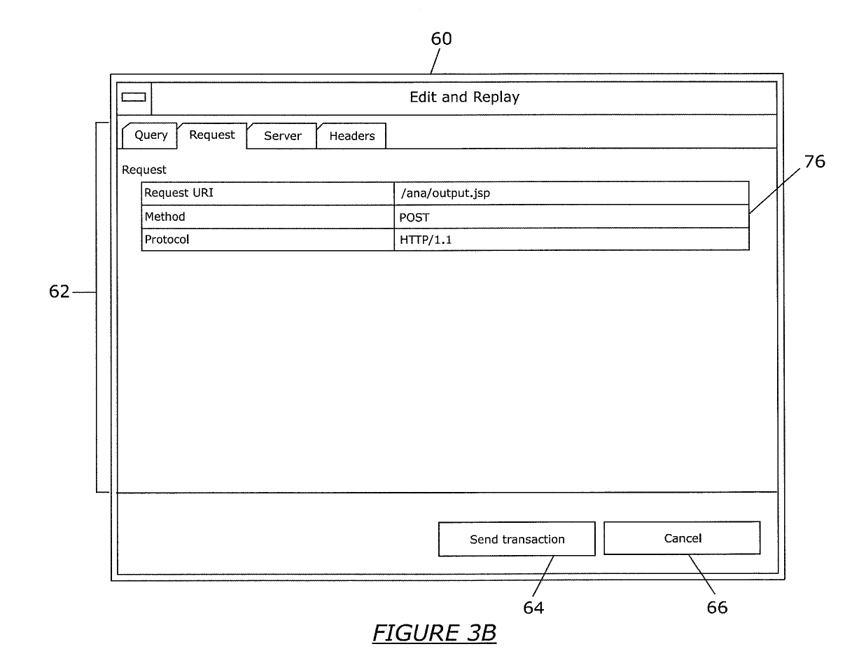

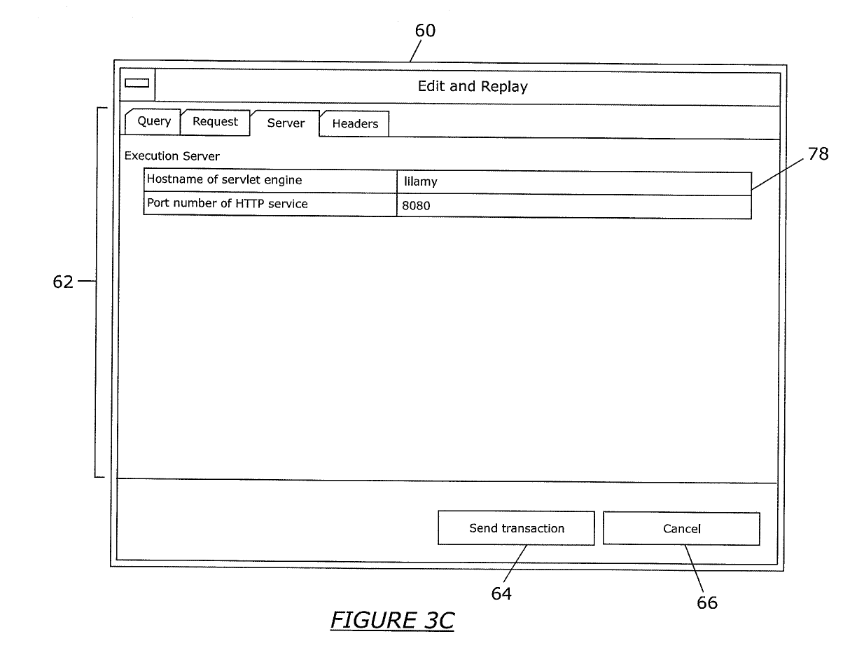

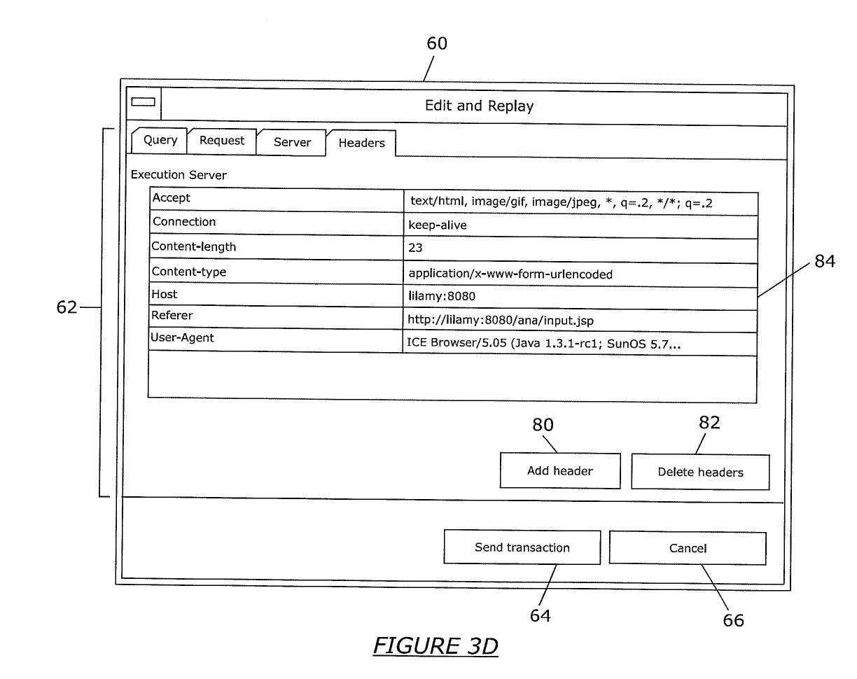

The “Edit and Replay” action allows a user to modify a copy of the request data for the selected HTTP transaction and then replay the modified request. When the user selects the “Edit and Replay” action, a dialog, such as dialog 60 in FIG. 3A, is displayed. The dialog 60 has four tabs 62, labeled “Query,” “Request,” “Server,” and “Headers,” respectively.

When the “Query” tab is selected, a table 68 with name/value of parameter pairs is displayed on the dialog 60. The user can edit the name/value of parameter pairs shown in table 68. The “Query” tab includes two buttons 70, 72, labeled “Add parameter” and “Delete parameter”. The “Add parameter” button 70 adds a new name/value pair to the table. The “Delete parameter” button 72 deletes a selected name/value pair. In the former case, a dialog (not shown) is displayed which allows the user to enter a name and value. In the latter case, a dialog (not shown) is displayed which confirms if the user wants to delete the selected name/value pair. The “Query” tab has a different appearance depending on whether the query is a GET or POST. If the query is a GET, then the table 68 and buttons 70, 72 are shown. If the query is a POST, a text box 74 is also shown. The text box 74 allows a query string to be added or edited.

FIG. 3B shows the “Request” tab displayed on the dialog 60. The “Request” tab includes a table 76, which allows the Request URI, the request method, and the protocol to be modified. New entries cannot be added to the table. FIG. 3C shows the “Server” tab displayed on the dialog 60. The “Server” tab includes a table 78 which allows the hostname and port of the server instance to be modified. New entries cannot be added to the table. FIG. 3D shows the “Headers” tab displayed on the dialog 60.

The “Headers” tab includes “Add header” button 80, “Delete headers” button 82, and a table 84 which displays headers. The user can click on the “Add header” button 80 to add a new header to the table 84 or on the “Delete headers” button to delete a header from the table 84.

The user can select each of the tabs 62 to modify the Query, Request, Server, and Headers data for a selected transaction. The original transaction data remains intact (inside the “current” or “saved” directories of directory 20 in FIG. 1), but the modified transaction data is saved in the “replay” directory (a subdirectory of directory 20 in FIG. 1) with the id of the original transaction. After the user modifies the request data, the user clicks on the “Send transaction” button 64 to send a request to the execution server (10 in FIG. 1) to replay the transaction. If the user does not wish to replay the transaction, the user clicks on the “Cancel” button 66.

In FIG. 2A, the transaction “POST output.jsp” is selected on the left pane 26, causing the associated transaction data to be displayed on the right pane 28. In the “posted data” section on the right pane 28, the value of parameter “val” is shown as “value.” To execute this transaction with a different value of parameter “val,” the user invokes the “Edit and Replay” action. When this action is invoked, the dialog 60 (shown in FIGS. 3A-3D) is displayed. To change the value of parameter “val,” the user selects the Query tab (shown in FIG. 3A). The Query tab is initially shown with the value of the parameter “val” as “value.” The user can then modify the value of the parameter “val” in the table 68. The Query tab shows the value of the parameter “val” modified to “new_value.” The user clicks on “Send transaction” button 64 to replay the transaction with the modified data. FIG. 2B shows the result. Note that in FIG. 2B a new transaction node has been added to the “Current Transactions” node. The data for the new transaction node is displayed on the right pane 28. Note that the value of the parameter “val” is now “new_value.”

Referring to FIGS. 2A and 2B, each of the nodes corresponding to the parent categories “All Transactions,” “Current Transactions,” and “Save Transactions” have a “Delete” action which causes the individual transactions underneath them to be deleted.

Invoking the “Delete” action on the “All Transactions” category deletes all transaction entries and removes all nodes from the GUI 22. Invoking “Delete” action on “Saved Transactions” deletes all saved transactions and removes the nodes under “Saved Transactions” category. Invoking “Delete” action on “Current Transactions” deletes all current transactions and removes the node under “Current Transactions” category.

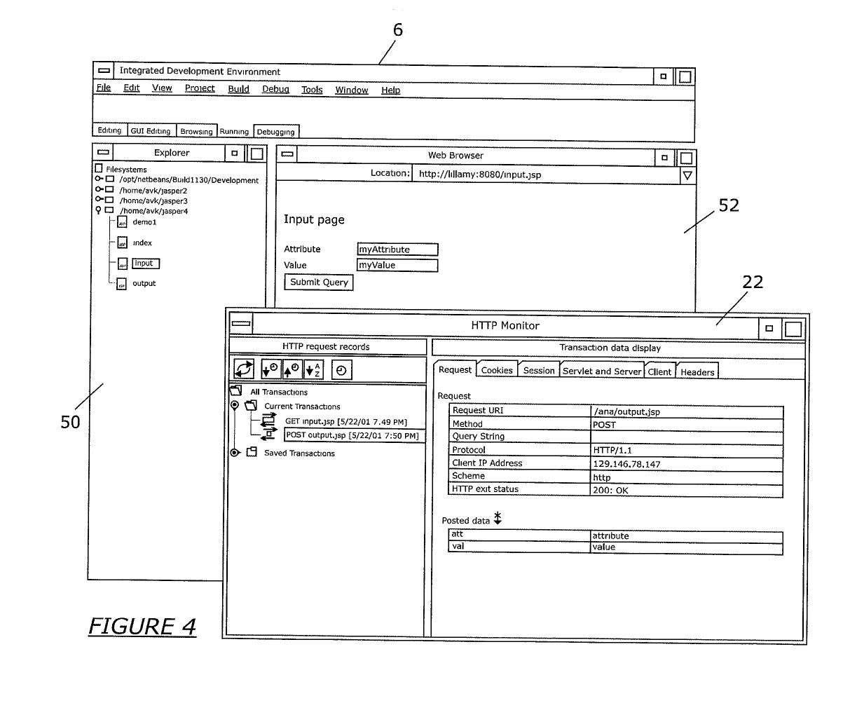

FIG. 4 shows the GUI 22 invoked from within a representation of the IDE 6.

The IDE 6 could be an IDE such as Forte™ for Java™ IDE from Sun Microsystems, Inc.

The Forte™ for Java™ IDE includes modules that assist in designing, debugging, and executing JSP™ pages and servlets. However, it should be clear that the invention is not limited to this particular IDE or for that matter to any IDE. The HTTP transaction monitor of the present invention can be used as a standalone tool with a web server. The invention is also not limited to IDEs that support development of JSP™ pages and servlets. In general, the invention can be applied to any development of web applications. In the illustrated embodiment, the user can invoke the GUI 22 by selecting the appropriate option in the menus, e.g., “Debug” or “View” menu, of the IDE 6. This displays the GUI 22 during the IDE session or until the GUI 22 is closed by the user. The IDE session is the period during which the user runs one instance of the IDE 6. The IDE session starts when the user brings up the IDE 6 and ends when the user exits the IDE 6.

### HTTP Transaction Monitor Server-side Functionality

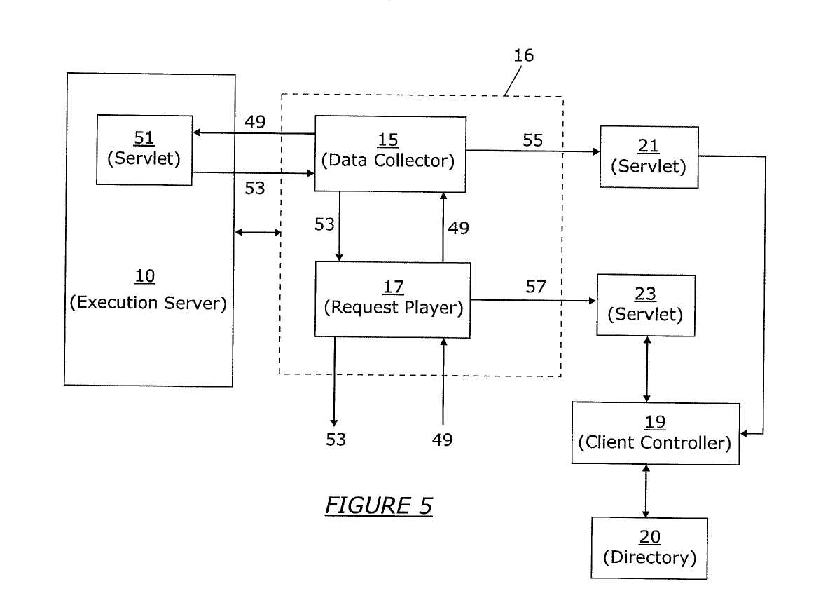

FIG. 5 illustrates how the server-side component 16 (previously shown in FIG. 1) operates in accordance with one embodiment of the invention. Suppose that a request 49 is coming into the execution server 10. Before the execution server 10 processes the incoming request 49, the request player 17 intercepts the incoming request 49 and checks whether the incoming request 49 is a replay request. In one embodiment, this involves looking for a specific query string, e.g., “ffj_resend,” in the URI of the incoming request. The query string appended to the URI may have the general form “ffj_resend=<id>&ffj_status={current,save,replay}.” If the query string matches this format, then the request player sends a HTTP request 57 to servlet 23 to provide the original transaction record for that id and status (i.e., where the transaction is a current, saved, or edited transaction). Servlet 23 uses the transaction id and status information to retrieve the (xml) file corresponding to the transaction record from the directory 20 and serves the file to the request player 17. Actually, the servlet 23 interacts with the client controller 19 which has access to the directory 20 and can retrieve files from the directory 20 using normal file operations. The request player 17 replaces the parameters and headers of the incoming request 49 with the data contained in the file received from the servlet 23. After modifying the incoming request 49, the request player 17 yields control to the data collector 15. If the incoming request 49 is not a replay request, the request player 17 immediately yields control to the data collector 15 without modifying the incoming request 49.

The data collector 15 intercepts the incoming request 49 and collects data about the request. The collected data includes information about the client making the request, the session state before the transaction, incoming cookies, properties of servlets and servlet engine running on the execution server 10, and all the request data except the exit status (see Table 1 above). After collecting data, the data collector 15 yields control to the execution server 10. The execution server 10 invokes a servlet 51 to process the request. The servlet 51 generates a response 53. After generating the response 53, the data collector 15 intercepts the response 53 and collects data about the response 53. The collected data includes information about the session state after the transaction, outgoing cookies, and the exit status of the response 53. The data collector 15 then notifies the client-side component (18 in FIG. 1) by sending a POST request 55 to the servlet (21 in FIG. 1). The POST request includes the recorded transaction data in xml format. The data collector 15 then yields control to the request player 17, which simply allows the response 53 to leave the execution server 10 without modification.

In one implementation, the request player 17 and data collector 15 rely on hooks on the execution server 10 to intercept incoming requests and outgoing responses. For the Tomcat web server, the “RequestInterceptor” API is used to intercept HTTP requests and responses, one for the data collection functionality and the other for the replay request functionality. The Tomcat web server is an open-source software project jointly run by Apache Software Foundation and Sun Microsystems Inc. The “RequestInterceptor” API provides hooks for invoking methods before and after the HTTP request is processed. The data collector 15 uses the “preService” method of one instance of the “RequestInterceptor” API to invoke methods which record data about the client, the session state before the transaction, the servlet properties data, incoming cookies, and all the request data except the exit status. The data collector 15 also uses the “postService” method of the same instance of the “RequestInterceptor” API to invoke methods which record outgoing cookies, session data after the transaction, and the exit status. The request player 17 uses the “preService” method of another instance of the “RequestInterceptor” API to intercept incoming requests, looking for query strings matching, for example, “ffj_resend.” The invention is not limited to the Tomcat web server, but may be implemented on any web server having an in-process or out-of-process servlet engine (also called servlet runner or web container).

In another implementation, hooks in a server plug-in on the execution server 10 are used to intercept HTTP requests and responses. For example, the “Filter” API, as described in the version 2.3 of the Java™ Servlet specification, could be used for the same purpose as the “RequestInterceptor” API.

### Operation

For the developer, the process of developing a web application involves, among other tasks, testing each dynamic web component (in the case of a Java™ application, each JSP™ and servlet) to see that it performs the correct processing and generates the appropriate output. This involves executing individual web components, and also sequences of components as they would be traversed by a user who browses the web site. Referring to FIG. 4, it is assumed that the web application to be tested has been developed, for example, using an IDE such as IDE 6. It is further assumed that the developer is using the IDE 6 to test-run and debug the web application. The contents of the web application is displayed in a GUI 50 that is included in the IDE 6. The developer can select a resource, e.g., JSP™ page or servlet or other component, in the web application and ask the IDE 6 to execute the resource. For example, in FIG. 4, a JSP™ page called “input” has been selected. To display the page, the IDE 6 sends an HTTP request to the execution server (10 in FIG. 1). The output of the execution server (10 in FIG. 1), i.e., the HTTP response, is displayed in the browser 52 which is included in the IDE 6.

Referring to FIG. 1, the first thing that happens when the execution server 10 receives an HTTP request is that the request player 17 examines it to see if it is a replay request. If the request is a replay request, the request player requests for the transaction file from servlet 23 and modifies the request with the transaction data. If the request is not a replay request, the request player 17 does not modify the request. Instead, the request player 17 yields control to the data collector 15. The data collector 15 then intercepts the request and collects data about the request. After collecting the data, control is returned to the execution server 10, and the execution server 10 processes the request. If the functionality is implemented using hooks in a server plug-in (as opposed to the execution server itself), control is yielded to the server plug-in. The execution server 10 invokes a servlet (not shown) generated from the JSP™ page with the data that came in with the HTTP request. After processing, the execution server 10 sends the response page back to the browser (52 in FIG. 4). Before the response page is sent to the browser 52, the data collector 15 again intercepts the response, collects data on the response, and then yields control back to the execution server 10. After collecting data, the data collector 15 notifies the servlet 21 of the new transaction. The servlet 21 in turn notifies the GUI 22 (through the client controller 19) to update its transaction list. The GUI 22 interacts with the client controller 19 to get the updated transaction data from the directory 20.

Using the data collected by the data collector 15, the developer can examine the attributes of requests coming into the execution server 10 and responses sent out from the execution server 10 through the GUI 22. If a problem arises, the developer can easily find the source of the problem by examining the transactions between the browser (52 in FIG. 4) and the server 10. If a particular request for a resource is one that the developer wants to make regularly throughout the development phase, for instance, in order to verify that the web application continues to work as intended after changes have been made, then the corresponding HTTP transaction can be saved. This allows the developer to replay the transaction during future IDE sessions. The developer can also use the save functionality in case they wish to defer fixing a problem to a later date. The transaction or transactions corresponding to the requests that reproduce the problem can be saved, giving the developer the opportunity to examine and replay them during a future IDE session. The request player 17 thus saves the developer the trouble of repeatedly accessing the web application resources through a web browser (as a user of the web application would), including reducing the need to fill in HTML forms to generate requests. Because the data collector 15 records data both for regular and replayed requests, it is easy to compare the results from one test-run to another.

The server-side component 16 intercepts all requests sent to the execution server 10, not just requests that are initiated from the IDE 6. This means that if the machine on which the execution server 10 is running is networked, then the server-side component 16 could process HTTP requests from clients on other machines. This feature can be useful in the testing phase. Suppose that a test engineer has identified a way of entering data into a web application that causes a problem for one of the dynamic components. Then the web developer could start up the execution server 10 with the server-side component 16. The test engineer can then, on his or her own machine, point a web browser to the host and port of the execution server 10 to access the web application and enter the data that reproduces the problem. The web developer can then use the client-side component 18 to examine what happened with the request and replay it as needed from the developer's own computer.

All HTTP requests that the sever-side component 16 intercepts, whether they originated from the IDE 6, from the client-side component 18 (as a replay request), or from another client, are available to the web developer to replay. With reference to the scenario described in the previous paragraph, suppose that the test engineer accessed two resources in the web application, one for a form and one for submitting the data from the form, resulting in two HTTP transactions on the “Current Transactions” lists. It is the second transaction, i.e., the one for submitting the data from the form, that will be associated with the bug. The web developer could first replay the second transaction to find out what is going wrong. Then the web developer could make changes to the web application with the aim to fix the problem. After making the changes, the web developer can then replay the same transaction again, this time to confirm that the bug has been fixed. Replaying the transaction saves the web developer from repeatedly loading the form corresponding to the first request and manually entering the data.

Returning to the example discussed in the background where the developer has identified a problem with how the input from one of the form fields in page A is processed by JSP_B. In this situation, the developer will attempt to fix the bug and then re-execute JSP_B with the same input from page A. If the developer used the tool of the present invention to start with, the original HTTP transaction will already have been stored by the client-side component (18 in FIG. 1). To re-execute JSP_B, the developer simply selects the HTTP transaction from the GUI (22 in FIG. 2A) and invokes the “Replay” action (see pop-up menu 29 in FIG. 2A). Now, suppose that the developer anticipates that another one of the form fields in page A could have a similar problem. To test this, the developer needs to modify the data in this form field. The developer can do this by selecting the HTTP transaction from the GUI (22 in FIG. 2A) and invoking the “Edit and Replay” action. This will display the dialog (31 in FIG. 2B), which will allow the developer to modify the data in the form field. The client-side component (18 in FIG. 1) can then send a replay request to the execution server (10 in FIG. 1) with the modified transaction data. A similar approach can be used when the developer desires to change other parameters such as locale setting of the client making the HTTP request.

As illustrated above, the invention provides general advantages in that it allows HTTP requests to be stored, edited, and replayed at a later time. In the context of testing and debugging applications, the invention saves time because it allows a problem to be rapidly reproduced without repeatedly entering the same data.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1] A mechanism for monitoring data flow in a web application hosted on a server, comprising:
a directory in which HTTP transactions processed on the server are stored;
a display through which a request associated with a selected HTTP transaction in the directory can be re-executed in order to recreate the selected HTTP transaction; and
an editor through which request data associated with the request can be modified prior to re-executing the request.

2] The mechanism of claim 1, further comprising a request player that reconstructs the request using an output of the editor.

3] The mechanism of claim 2, wherein the output of the editor comprises a modification of the request data.

4] The mechanism of claim 3, wherein the modification of the request data is stored in the directory.

5] The mechanism of claim 4, further comprising means for retrieving the modification of the request data from the directory.

6] The mechanism of claim 1, further comprising a data collector that selectively intercepts the HTTP transactions processed on the server in order to collect data passed between components of the web application.

7] The mechanism of claim 6, further comprising means for storing the data collected by the data collector in the directory.

8] The mechanism of claim 6, further comprising means for notifying the display of data collected by the data collector.

9] A mechanism for monitoring data flow in a web application hosted on a server, comprising:
a data collector that selectively intercepts HTTP transactions processed on the server in order to collect data passed between components of the web application;
a display through which a request associated with a selected HTTP transaction for which data has been collected can be sent to the server; and
an editor through which request data associated with the request can be modified prior to re-executing the request.

10] The mechanism of claim 9, further comprising a request player that reconstructs the request using an output of the editor.

11] The mechanism of claim 10, wherein the output of the editor includes a modification of the request data.

12] The mechanism of claim 11, wherein the modification of the request data is stored in a directory.

13] The mechanism of claim 12, further comprising means for retrieving the modification of the request data from the directory.

14] The mechanism of claim 12, further comprising means for storing the data collected by the data collector in the directory.

15] A method for monitoring data flow in a web application hosted on a server, comprising:
obtaining an HTTP transaction processed on the server while interacting with the web application, the HTTP transaction having an associated request;
editing request data associated with the request;
reconstructing the request using the edited request data; and
re-executing the request in order to recreate the HTTP transaction.

16] The method of claim 15, wherein obtaining the HTTP transaction comprises retrieving the HTTP transaction from a directory containing HTTP transactions processed on the server.

17] The method of claim 16, wherein obtaining the HTTP transaction further includes selecting the HTTP transaction through a display that includes a list of the HTTP transactions in the directory.

18] The method of claim 15, wherein editing request data associated with the request comprises editing a copy of the request data.

19] The method of claim 18, wherein editing the copy of the request data comprises storing the edited copy of the request data in a directory.

20] The method of claim 19, wherein re-constructing the request using the edited request data comprises retrieving the copy of the request data from the directory and associating the copy of the request data with the request.

21] The method of claim 15, further comprising collecting data passed between components of the web application before and after the request is re-executed.

22] The method of claim 21, further comprising displaying the collected data.

23] A system for testing and debugging a web application, comprising:
a server hosting the web application;
a directory in which HTTP transactions processed on the server are stored;
a client through which a request associated with a selected HTTP transaction in the directory can be re-executed in order to recreate the selected HTTP transaction; and
an editor through which request data associated with the request can be modified prior to re-executing the request.

24] The system of claim 23, wherein an output of the editor comprises a modification of the request data.

25] The system of claim 24, wherein the client reconstructs the request using the modification of the request data.

26] The system of claim 24, further comprising a request player running on the server which reconstructs the request using the modification of the request data.

27] The system of claim 23, further comprising a data collector running on the server which intercepts HTTP transactions processed on the server in order to collect data passed between components of the web application.

28] The system of claim 23, wherein the client includes an action for invoking the editor.

29] The system of claim 28, wherein the client includes a controller which manages access to the directory.

30] The system of claim 28, further comprising an application which starts the server in a separate process and through which the client can be started.

31] The system of claim 30, wherein the application is an integrated development environment.

32] The system of claim 30, wherein the application includes an internal HTTP server.

33] The system of claim 32, wherein the internal HTTP server includes a mechanism for receiving data from the data collector and notifying the client of the collected data.

34] A mechanism for monitoring data flow in a web application hosted on a server, comprising:
means for storing HTTP transactions processed on the server;
means for re-executing a request associated with a selected HTTP transaction in the directory in order to recreate the selected HTTP transaction; and
means for modifying request data associated with the request prior to re-executing the request.
